(19) United States
(12) Patent Application Publication
(10) Pub. No.: US 2012/0096390 A1
(43) Pub. Date: Apr. 19, 2012

(54) METHOD OF PROVIDING A USER LIST AND DEVICE ADOPTING SAME

(76) Inventors: Ji-Young Kwahk, Seongnam-si (KR); Giang-yoon Kwon, Seoul (KR); Jin-Young Jeon, Seoul (KR); Sang-woong Hwang, Gyeonggi-do (KR); Jee-Sun Yoon, Seoul (KR)

(21) Appl. No.: 13/377,363

(22) PCT Filed: Jun. 9, 2010
(86) PCT No.: PCT/KR10/03705

§ 371 Date: Dec. 9, 2011

(30) Foreign Application Priority Data
Jun. 9, 2009 (KR) 10-2009-0050854

(51) Int. Cl. G06F 3/048

(52) U.S. Cl. 715/779

(57) ABSTRACT

A method of providing a user list and a device adopting the method are provided. The method includes displaying a first task list, in which at least one task selected by a first user is includable, in a first area of a display; and displaying a second task list, in which at least one task selected by a second user is includable, in a second area of the display. Therefore, if users perform different jobs by sharing one device, the users individually, conveniently, and efficiently manage and perform their respective jobs by using lists which include tasks desired by the users.

### PRIORITY

This application claims priority to PCT Application No. PCT/KR2010/003705, filed Jun. 9, 2010, and to Korean Patent Application No. 10-2009-0050854, filed on Jun. 9, 2009, the contents of each of which are incorporated herein by reference.

### BACKGROUND OF THE INVENTION

1. Field of the Invention

The present invention generally relates to a method of providing a user list, and more particularly, to a method of providing a list desired by each user and a device adopting the method.

2. Description of the Related Art

In general, in the case of a portable device, one user uses one device. However, in the case of a mounted type device, several users frequently share one device.

If several users share one device, one of the several users generally controls the device. However, if necessary, each of the several users can control the device together.

In this case, users perform different jobs by using a device. A Graphical User Interface (GUI) is required in this environment so that the users further efficiently collaborate to perform the different jobs by using one device and efficiently manage their individual jobs.

### SUMMARY OF THE INVENTION

The present invention provides a method of providing user lists that include different tasks or applications according to each respective user.

According to an aspect of the present invention, there is provided a method for providing a user list including displaying a first task list, in which at least one task selected by a first user is includable, in a first area of a display; and displaying a second task list, in which at least one task selected by a second user is includable, in a second area of the display.

The method may further include, if one task included in the first task list is moved to a third area of the display by the first user, displaying a task execution window in which the moved task has been executed.

The method may further include making the moved task disappear from the first task list.

The task execution window may be displayed in a direction appropriate for the first user to view.

The third area may be an area which is shared by the first and second users.

The method may further include, if the task execution window displayed in the third area of the display is moved to the first task list, additionally including a task, which is executed in the moved task execution window, in the first task list.

The method may further include making the moved task execution window disappear from the third area of the display.

The method may further include, if one task included in the first task list is moved toward a first direction, deleting the moved task from the first task list.

The first direction may be a direction which faces a side of the display.

The method may further include displaying information for specifying the first user around the first task list.

The first area of the display in which the first task list is displayed may be an area which is adjacent to one of four sides of the display nearest to the first user.

The first task list may be displayed in a direction appropriate for the first user to view.

At least one task, which is first included in the first task list, may be determined by information obtained from a storage medium possessed by the first user.

The method may further include displaying a first application list, in which at least one application selected by the first user is includable, on the display.

The display of the first application list may be performed if an icon positioned around the first task list is selected by the first user.

At least one application, which is first included in the first application list, may be determined by information obtained from the storage medium possessed by the first user.

A direction in which applications are listed in the first application list may be different from a direction in which tasks are listed in the first task list.

The method may further include, if one of applications included in the first application list is moved to the third area of the display by the first user, displaying an application execution window in which the moved application has been executed.

The method may further include moving and displaying the first task list to a position command by the first user.

When moving and displaying the first task list, the first task list may be rotated and displayed in a direction appropriate to be looked at on a side of the display adjacent to the position.

The method may further include, if a particular icon displayed on the display is selected, displaying a third task list, in which tasks are includable, on the display; and if a command to end the third task list is input, making the third task list disappear and displaying the particular icon.

According to another aspect of the present invention, there is provided a device including a display and a controller which displays a first task list, in which at least one task selected by a first user is includable, in a first area of the display and displays a second task list, in which at least one task selected by a second user is includable, in a second area of the display.

According to another aspect of the present invention, there is provided a method for providing a user list. The method may include displaying in a first area of a display a first application list in which at least one application selected by a first user is included, and displaying in a second area of the display a second application list in which at least one application selected by a second user is includable.

As described above, according to the present invention, user lists which include different tasks or applications according to respective users are provided. Therefore, when users perform different jobs by using a shared single device, the users conveniently and efficiently manage and use their individual jobs by using lists which include tasks or applications respectively desired by the users.

### BRIEF DESCRIPTION OF THE DRAWINGS

The above and other aspects, features and advantages of embodiments of the present invention will be more apparent from the following description taken in conjunction with the accompanying drawings, in which:

FIGS. 1 through 8 illustrate a user tray and a task tray;

FIGS. 9 through 13 illustrate an application tray;

FIGS. 14 through 17 illustrate task/application scrolling;

FIGS. 18 through 21 illustrate task/application order replacement;

FIGS. 22 through 27 illustrate highlight of a task included in a task tray;

FIGS. 28 through 31 illustrate a method of moving a user tray to another position of a touch screen;

FIGS. 32 and 33 illustrate a method of ending a user tray to make the user tray disappear from a touch screen;

FIGS. 34 through 36 illustrate a realization of user trays for many users;

FIGS. 37 through 40 illustrate a guest tray;

FIG. 41 is a block diagram of a device according to an embodiment of the present invention; and

FIG. 42 is a flowchart illustrating a control process performed by a controller.

### DETAILED DESCRIPTION OF EMBODIMENTS OF THE INVENTION

The present invention will now be described in more detail with reference to the attached drawings.

The present invention suggests a user tray. The user tray includes a task tray and an application tray.

The task tray refers to a Graphical User Interface (GUI) which includes tasks selected by a user, i.e., corresponds to a list of tasks selected by the user.

A task refers to a job which is performed by an application according to a user command. For example, the task refers to a job which is performed by a word processor so that a user can view and edit a document file designated by the user, a job which is performed by an image viewer to read an image file designated by the user so that the user can view the image file, a job which is performed by an Internet browser so that the user can surf the Internet, or a job which is performed by the Internet browser so that the user can use a webpage of a Uniform Resource Locater (URL) designated by the user.

An execution result of a task executed by an application appears in a task execution window. For example, the execution result of the task appears in a window in which a word processor reading a document file designated by a user has been executed.

The application tray refers to a GUI which includes applications selected by the user, i.e., corresponds to a list of applications selected by the user.

### 1. User Tray & Task Tray

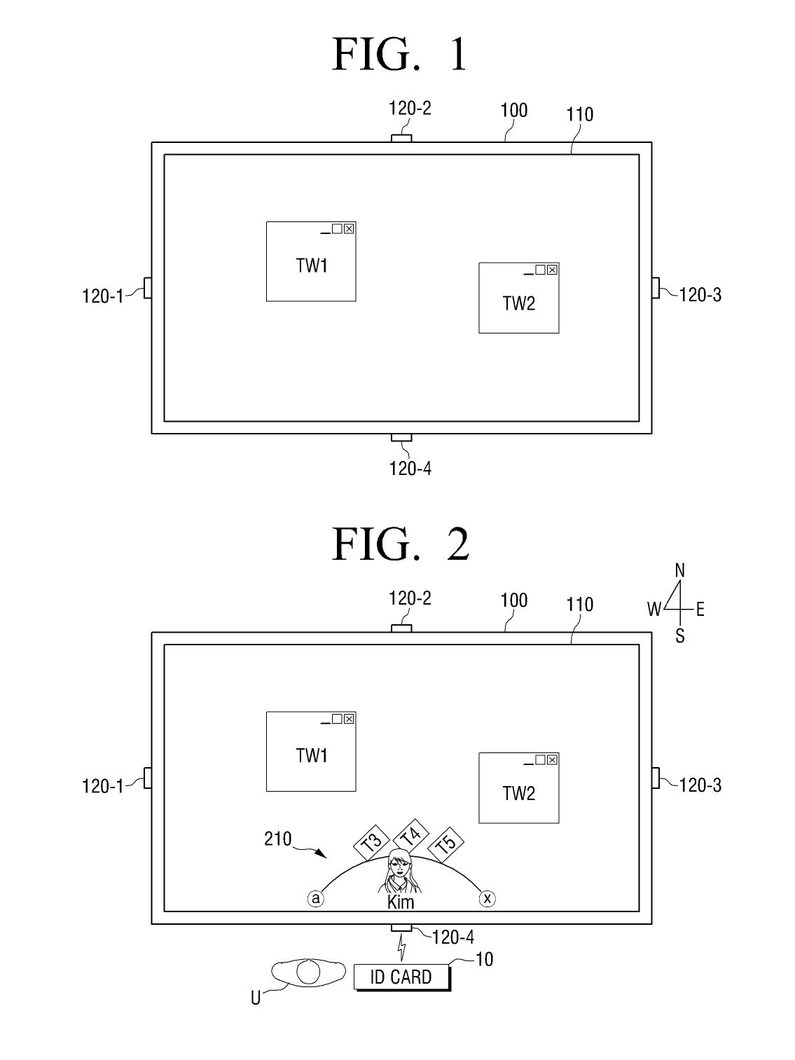

FIGS. 1 through 8 illustrate a user tray and a task tray. A tabletop device 100 used in a digital conference is shown in FIG. 1. As shown in FIG. 1, a touch screen 110 is provided in an upper part of the tabletop device 100, and first through fourth card readers 120-1 through 120-4 are provided on a respective side of the four sides of the tabletop device 100.

Referring to FIG. 1, first and second task execution windows TW1 and TW2 appear on the touch screen 110. The first and second task execution windows TW1 and TW2 refer to windows in which execution results of tasks executed by applications installed in the tabletop device 100 appear, as described above.

The first task execution window TW1 refers to a window in which an execution result of a first task T1 (FIG. 6) appears, and the second task execution window TW2 refers to a window in which an execution result of a second task appears.

Referring to FIG. 2, a user U having an identification (ID) card 10 accesses a south side of the tabletop device 100 to bring the ID card 10 into contact with the fourth card reader 120-4 provided on the south side of the tabletop device 100.

If the ID card 10 of the user U contacts the fourth card reader 120-4 as described above, a user tray 210 appears on the south side of the touch screen 110 of the tabletop device 100, as shown in FIG. 2.

As shown in FIG. 2, a task tray 210 also shown as (symbol “ [symbol] ”, one end at an application calling/ending icon \textcircled{a} and another end at a user tray ending icon \textcircled{x}) with user information appearing in the user tray 210.

### 1.1) Task Tray

Third, fourth, and fifth tasks T3, T4, and T5 are listed on a north side of the task tray shown in FIG. 2. The third, fourth, and fifth tasks T3, T4, and T5 refer to tasks which are selected by the user U and included in the task tray.

In the present embodiment, items listed in the task tray ( [symbol] ) are not tasks, but are icons symbolizing the tasks, and the icons may be displayed as thumbnail images that symbolize respective tasks.

However, for reference herein, the tasks are listed in the task tray [symbol] .

Information about which tasks are included in the task tray [symbol] is recorded in the ID card 10 of the user U. Therefore, the tabletop device 100 determines the third, fourth, and fifth tasks T3, T4, and T5 which are to be first included in the task tray [symbol] , based on the information which is recorded in the ID card 10 of the user U and is read by the fourth card reader 120-4.

1.2) Application Calling/Ending Icon \textcircled{a}

The application calling/ending icon \textcircled{a} appearing on a south side of the task tray is used to call an application tray through a touch input. The application tray will be described in detail below.

1.3) User Tray Ending Icon \textcircled{x}

The user tray ending icon \textcircled{x} appearing on an east side of the task tray [symbol] is used to input a user tray ending command (i.e., a command to make a user tray disappear from the touch screen 110) through a touch input.

### 1.4) User Information

The user information appearing on the south side of the task tray ( [symbol] ) is information which specifies the user U having the ID card 10 contacting the fourth card reader 120-4. In FIG. 2, the user information includes a picture and a name of the user U (“Kim”). The user U easily recognizes the user tray that belongs to user U, via the user information.

A method of controlling the third, fourth, and fifth tasks T3, T4, and T5 included in the task tray [symbol] will now be described in detail.

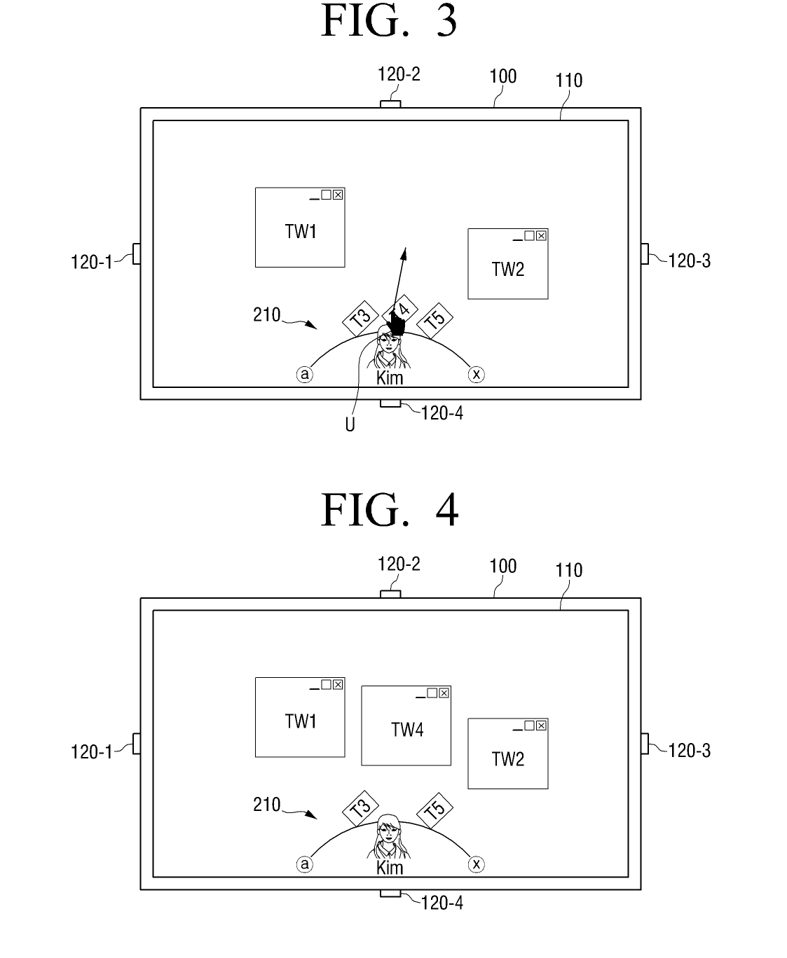

FIGS. 3 and 4 illustrate a method of executing tasks included in the task tray [symbol] .

As shown in FIG. 3, a task execution command is input by using a Dragging and Dropping (D&D) method by which the fourth task T4 of the third, fourth, and fifth tasks T3, T4, and T5 of the task tray [symbol] that the user desires to execute is dragged and dropped onto a wallpaper.

Referring to FIG. 4, after the user U control described in regard to FIG. 3, the fourth task T4 disappears from the task tray [symbol] , and a fourth task execution window TW4 appears on the wallpaper. Here, the fourth task execution window TW4 appears in a position into which the fourth task T4 is dropped.

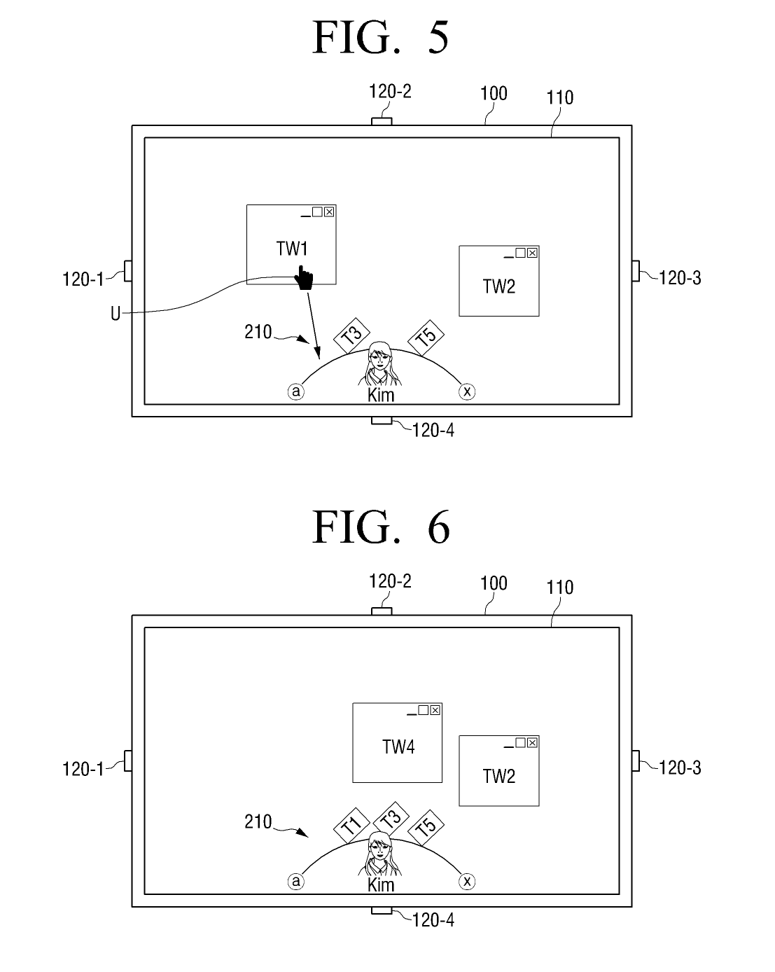

FIGS. 5 and 6 illustrate a method of including a task execution window, which appears on the wallpaper, as a task in the task tray [symbol] .

As shown in FIG. 5, a task including command is input by using a D&D method by which the first task execution window TW1 of task execution windows that the user U wants to include in the task tray [symbol] is dragged and dropped into the task tray [symbol] , wherein the task execution windows appear on the wallpaper.

Referring to FIG. 6, through the control of the user U as shown in FIG. 5, the first task execution window TW1 disappears from the wallpaper, and the first task T1 is included in the task tray [symbol] .

The task tray [symbol] is a personal area for use by only one user, and the wallpaper is a sharable area for all of users of the tabletop device 100. Therefore, executing a task of the task tray [symbol] on the wallpaper may be regarded as an action for allowing all of the users to share a task of any one user. Also, including a task executed on the wallpaper in the task tray [symbol] may be regarded as an action for cancelling the task from being shared by all users and managing the task through only one user.

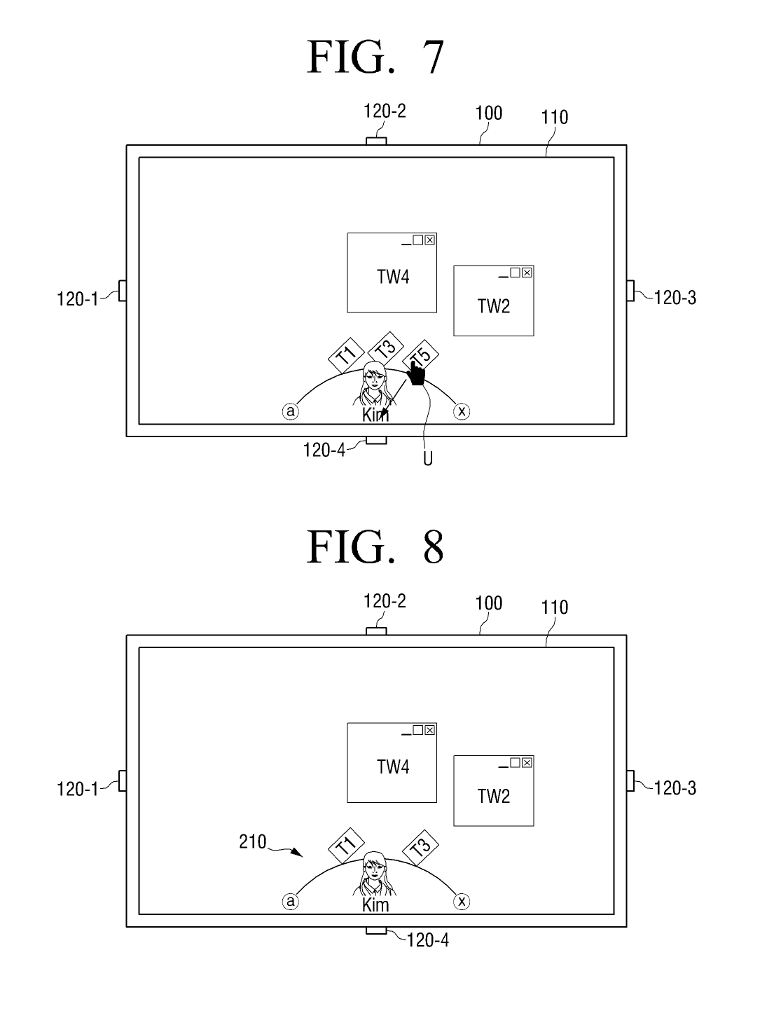

FIGS. 7 and 8 illustrate a method of deleting a task included in the task tray [symbol] .

As shown in FIG. 7, a task deleting command is input by a D&D method by which the fifth task T5 of tasks of the task tray [symbol] that the user U desires to delete is dragged and dropped outside the touch screen 110 adjacent to the task tray [symbol] .

Referring to FIG. 8, the fifth task T5 is deleted from the task tray [symbol] through the control of the user U as shown in FIG. 7.

### 2. Application Tray

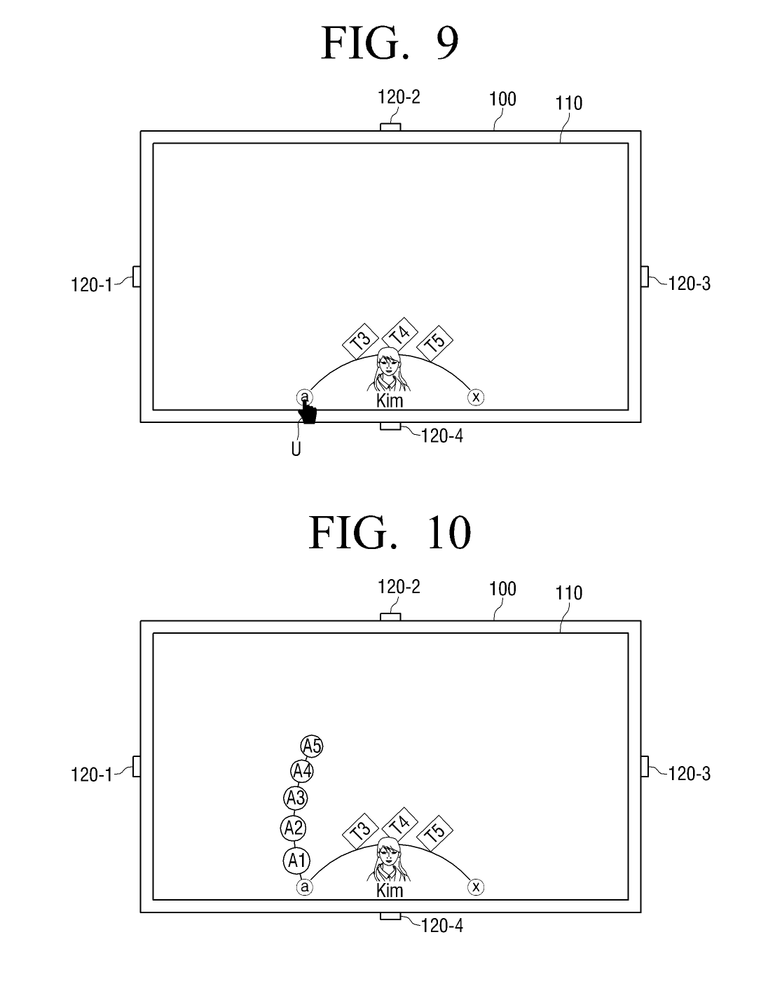

FIGS. 9 through 13 illustrate an application tray. As shown in FIG. 9, the user U touches the application calling/ending icon \textcircled{a} to input an application tray entry.

Referring to FIG. 10, an application tray is called through a user input as shown in FIG. 9. As shown in FIG. 10, first through fifth applications A1 through A5 are listed in the application tray. The first through fifth applications A1 through A5 are applications which are selected by the user U and included in the application tray.

Information about which applications are included in the application tray is recorded in the ID card 10 (FIG. 2) of the user U. Therefore, the tabletop device 100 determines the first through fifth applications A1 through A5 which are to be first included in the application tray, based on the information which is recorded in the ID card 10 of the user U and read by the fourth card reader 120-4.

Accordingly, applications included in the application tray vary according to users.

The first through fifth applications A1 through A5 are listed in a different direction from that in which the third, fourth, and fifth tasks T3 through T5 are listed. In other words, a direction (D) of the application tray is different from that of the task tray [symbol] .

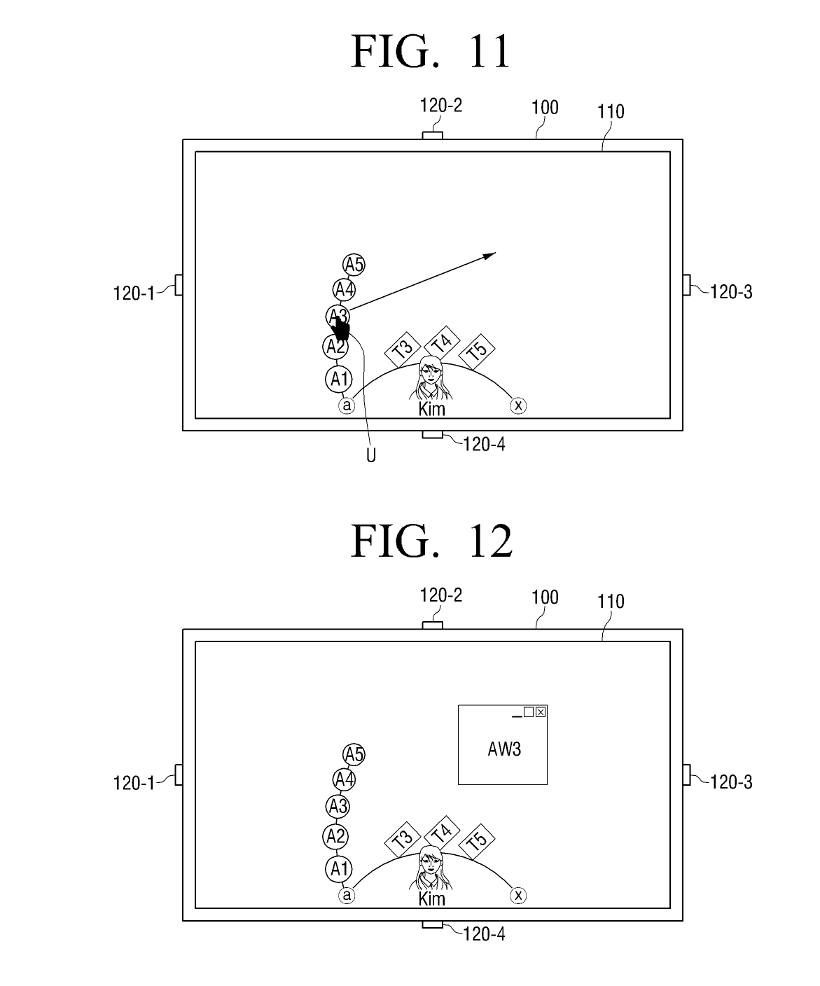

FIGS. 11 and 12 are views illustrating a method of executing an application included in the application tray.

As shown in FIG. 11, an application executing command is input by using a D&D method by which the third application A3 of the first through fifth applications A1 through A5 of the application tray that the user U desires to execute is dragged and dropped onto the wallpaper.

Referring to FIG. 12, the third application A3 is executed through the control of the user U as shown in FIG. 11, and thus a third application execution window AW3 appears on the wallpaper. Here, the third application execution window AW3 appears in a position into which the third application A3 is dropped.

Different from a task which disappears from the task tray [symbol] if the task is executed on the wallpaper, an application does not disappear from the application tray, although the application is executed on the wallpaper, to allow the application to be repeatedly executed later.

The third application execution window AW3 appearing on the wallpaper may execute a particular task. For example, a case where after the third application execution window AW3 appears, the user U reads a particular document file through the third application execution window AW3. In this case, the third application execution window AW3 corresponds to a task execution window. Therefore, the third application execution window AW3 which is the task execution window, may be included in the task tray [symbol] , and a method for inclusion thereof is described above and is not repeated here to avoid redundancy.

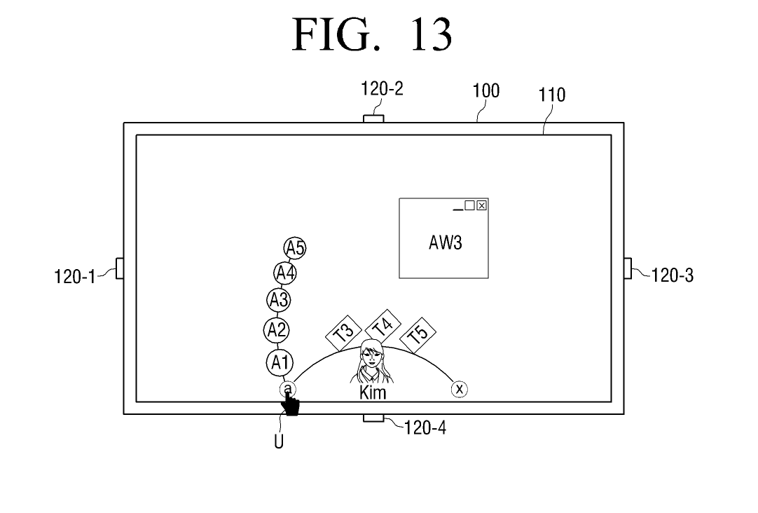

As shown in FIG. 13, if the user U touches the application calling/ending icon \textcircled{a} when the application tray appears, the application tray disappears and thus returns to a state shown in FIG. 9.

### 3. Task/Application Scrolling

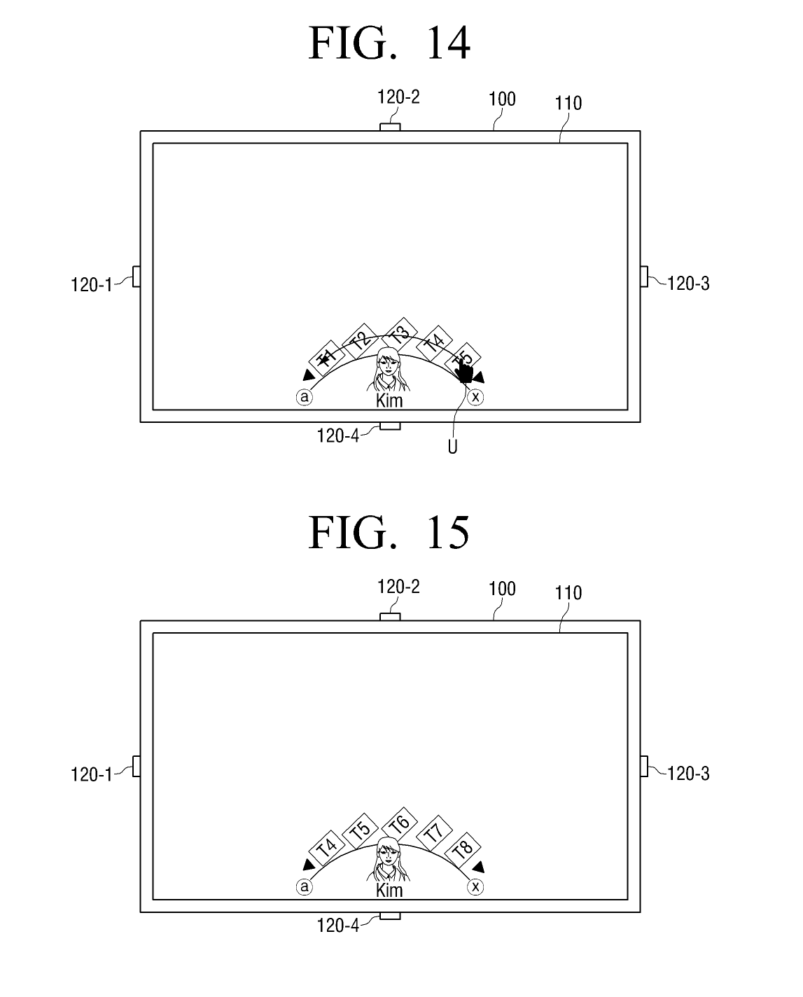

FIGS. 14 and 15 illustrate a scrolling of tasks included in the task tray [symbol] . Task scrolling is used to search for tasks which are not displayed when all of the tasks included in the task tray [symbol] may not be displayed.

As shown in FIG. 14, the user U pans or flicks the task tray [symbol] to input the task scrolling. Referring to FIG. 15, tasks included in the task tray [symbol] are scrolled through a user input, as shown in FIG. 14.

Panning by the user U for task scrolling may be input in an opposite direction to that shown in FIG. 14.

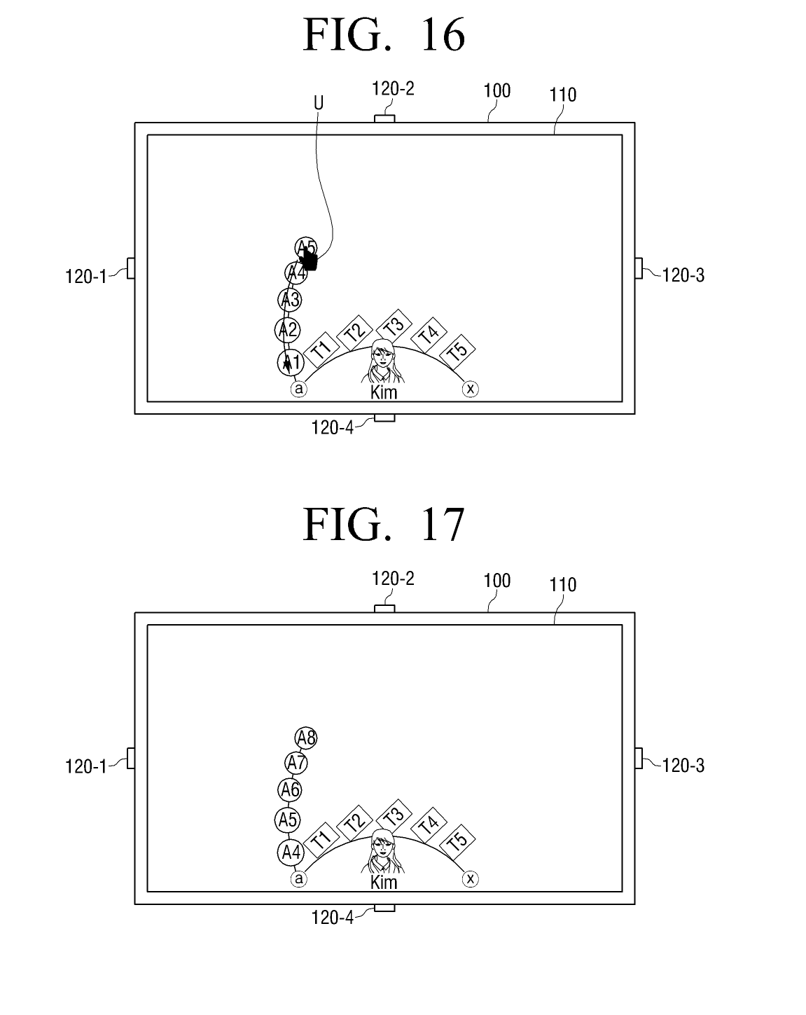

FIGS. 16 and 17 illustrate a scrolling of applications included in the application tray. Application scrolling is used to search for applications which are not displayed when all of applications included in the application tray are not displayed.

As shown in FIG. 16, the user U pans or flicks the application tray to input the application scrolling. Referring to FIG. 17, the applications included in the application tray are scrolled through the user input, as shown in FIG. 16.

Panning by the user U for the application scrolling may be input in an opposite direction to that shown in FIG. 16.

### 4. Task/Application Order Replacement

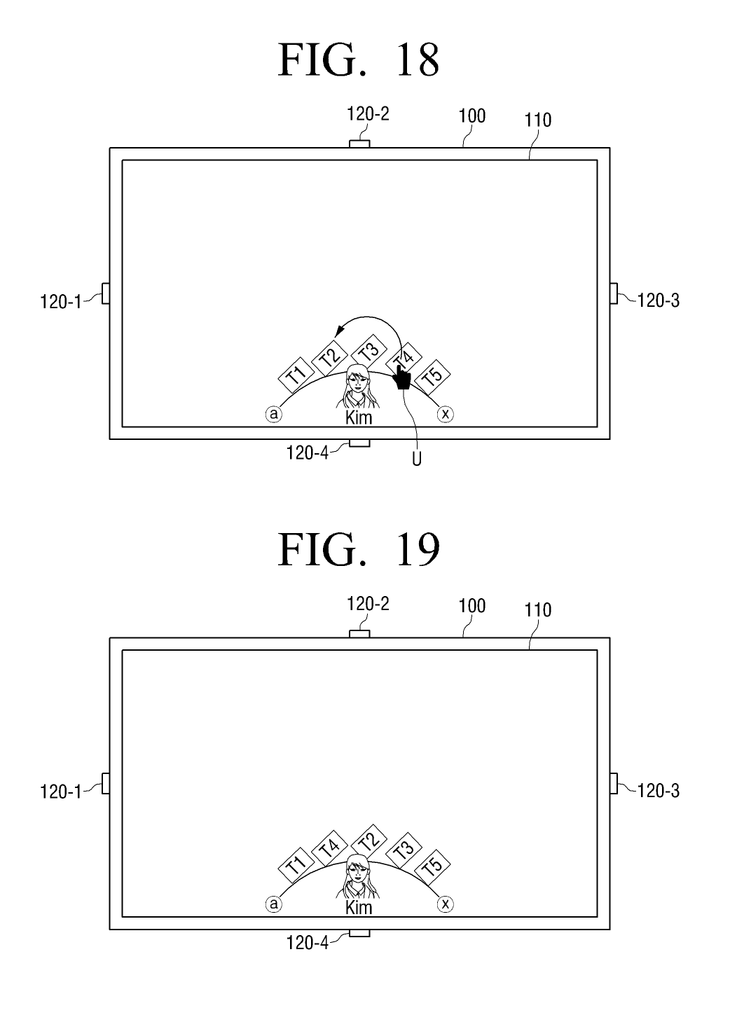

FIGS. 18 and 19 illustrate replacement of orders of tasks included in the task tray [symbol] .

As shown in FIG. 18, a task order replacing command is input by using a D&D method by which a fourth task T4 among the tasks of the task tray [symbol] that the user U desires to change a position of a desired order is dragged and dropped into the position in the desired order. Referring to FIG. 19, the order of the fourth task T4 included in the task tray [symbol] is repositioned ahead of second task T2 via user input, as shown in FIG. 18.

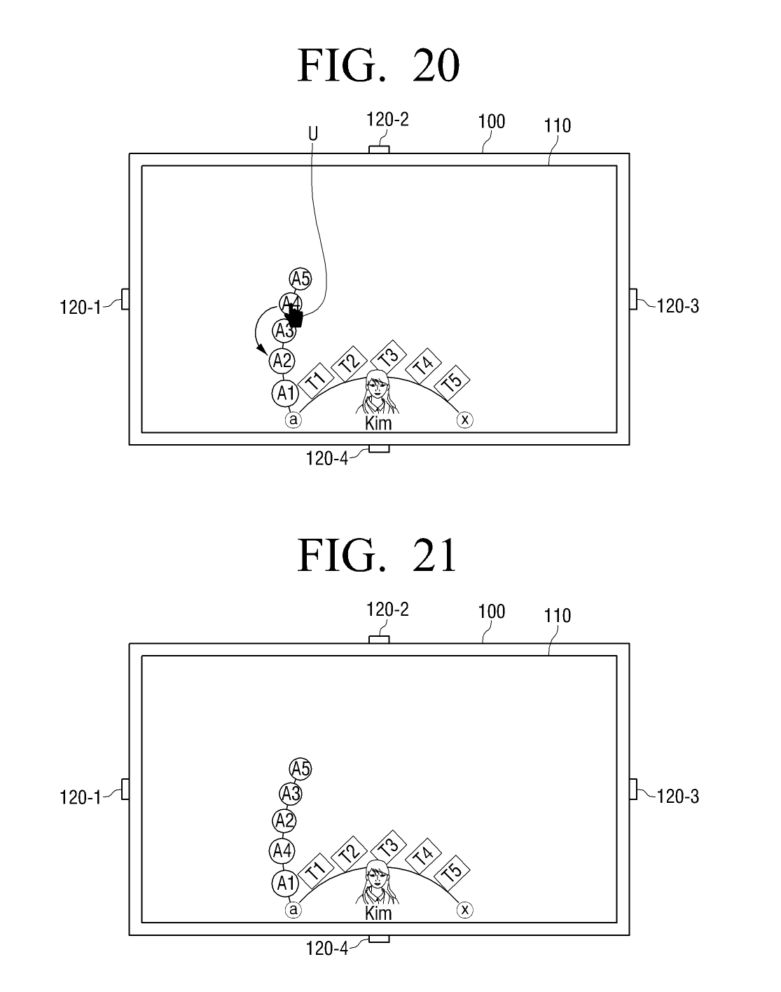

FIGS. 20 and 21 illustrate replacement of orders of applications included in the application tray.

As shown in FIG. 20, an application order replacing command is input by using a D&D method by which the fourth application A4 among the applications of the application tray that the user U desires to change to a position of a desired an order is dragged and dropped into the position of the desired order. Referring to FIG. 21, the order of the fourth application A4 included in the application tray is repositioned via the user input shown in FIG. 20.

### 5. Task/Application Highlight

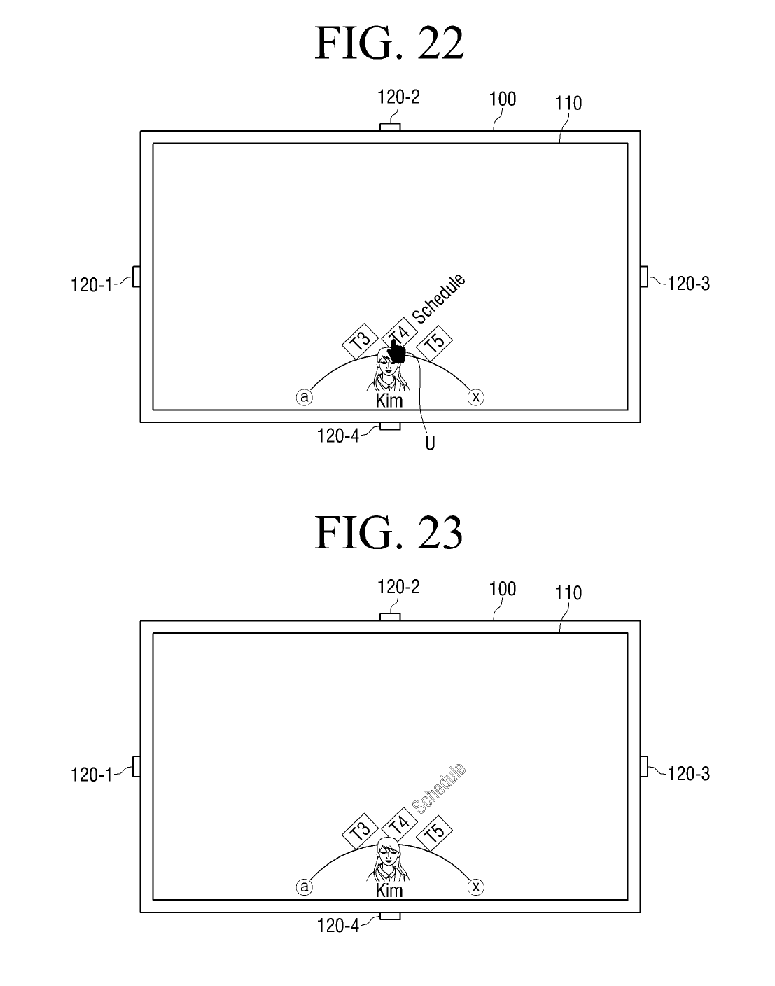

FIG. 22 illustrates highlighting a task included in the task tray [symbol] . As shown in FIG. 22, the user U touches the desired fourth task T4 among the tasks of the task tray [symbol] to highlight the fourth task T4. As shown in FIG. 22, a title “Schedule” of the highlighted fourth task T4 appears beside the highlighted fourth task T4.

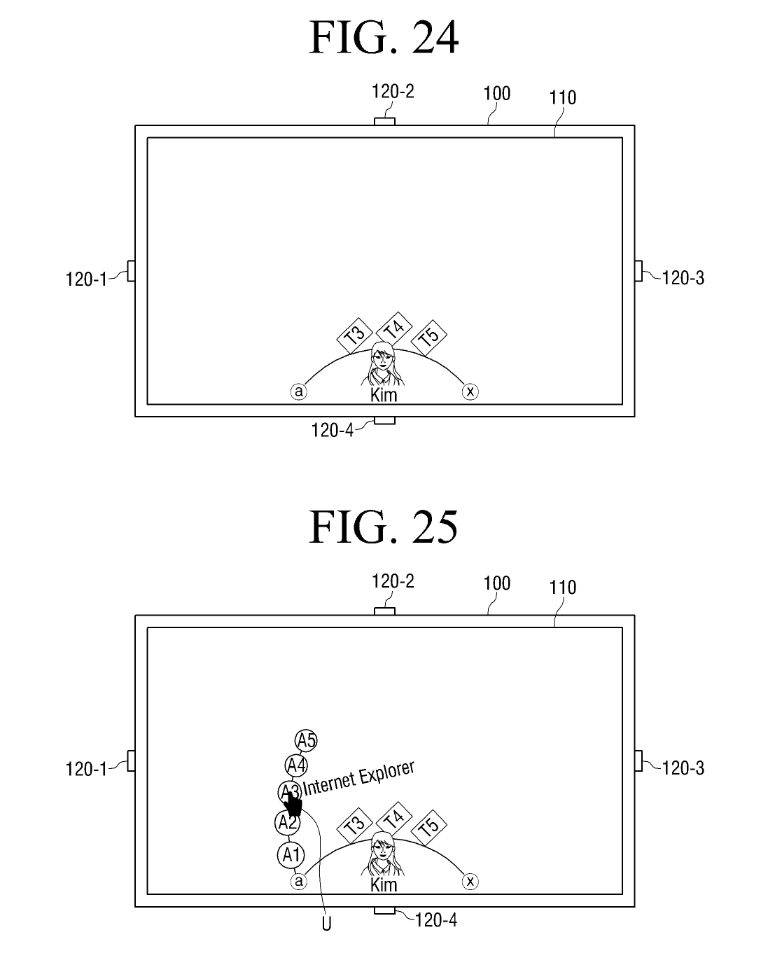

As shown in FIGS. 23 and 24, if the touch of the user U is withdrawn, the title “Schedule” of the highlighted fourth task T4 gradually disappears.

FIG. 25 illustrates highlighting of an application included in the application tray. As shown in FIG. 25, the user U touches a desired application among the applications included in the application tray to highlight the desired application. As shown in FIG. 25, a title “Internet Explorer” of the highlighted application appears beside the highlighted application A3.

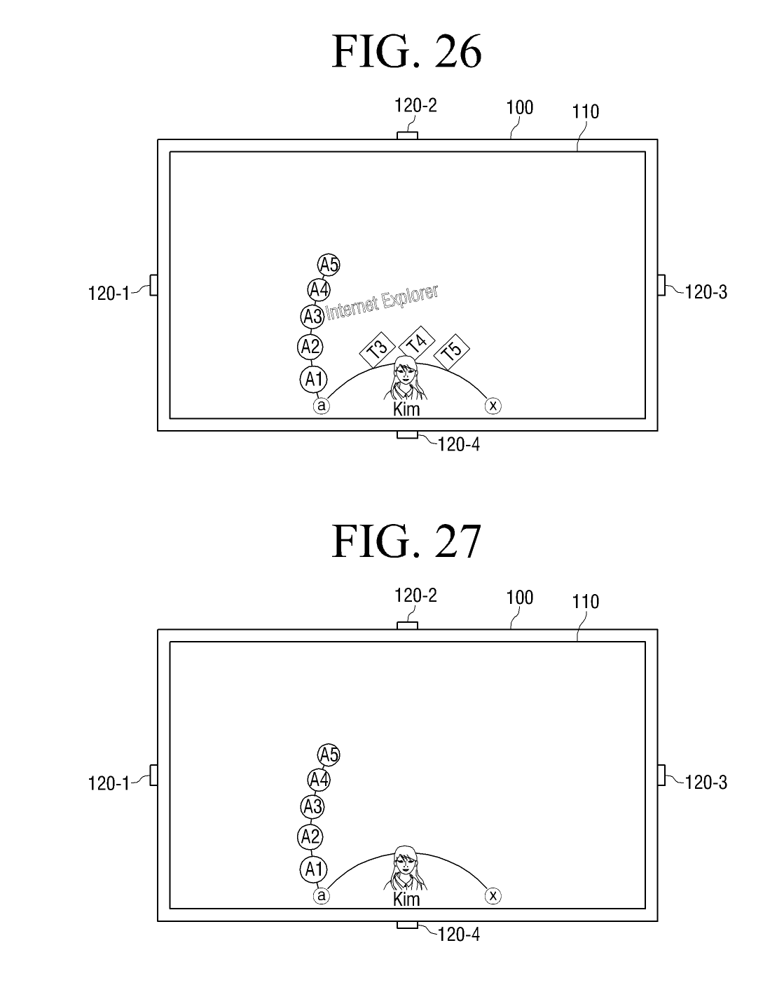

As shown in FIGS. 26 and 27, if the touch of the user U is withdrawn, the title “Internet Explorer” of the highlighted application gradually disappears.

### 6. Movement of User Tray

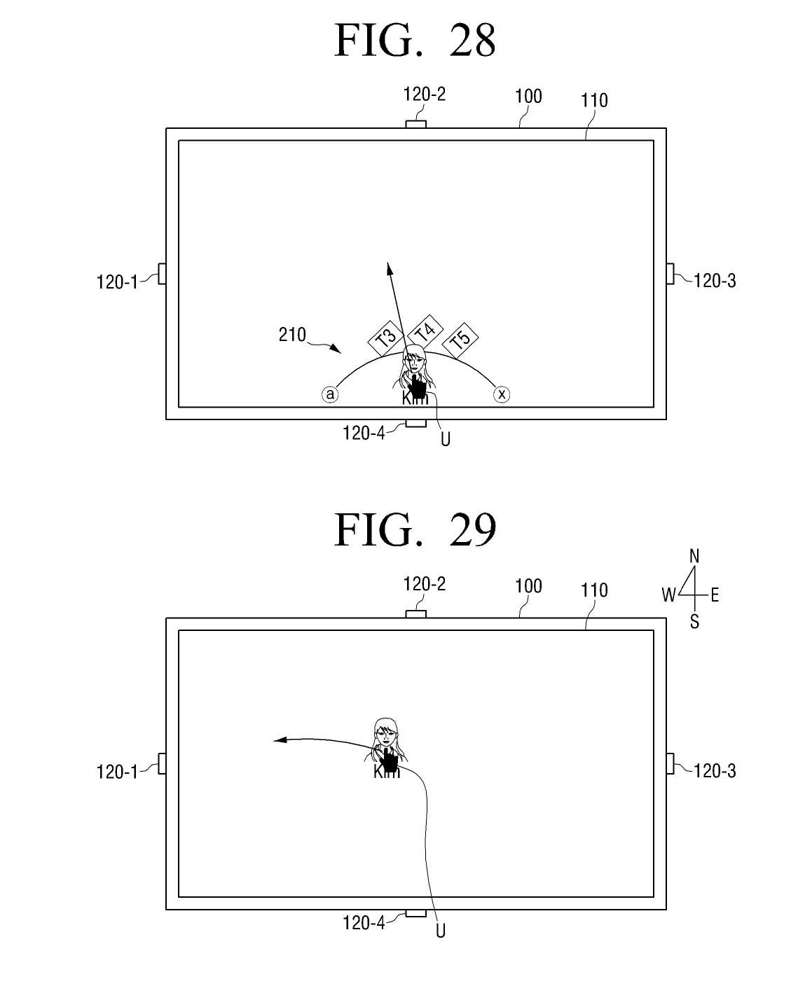

FIGS. 28 through 31 illustrate a method of moving the user tray 210 into another position of the touch screen 110.

As shown in FIG. 28, a user tray movement is input by dragging and dropping user information appearing in the user tray 210 into a desired position.

In FIGS. 29 through 31, by dragging and dropping of the user information by the user U, the user tray 210 adjacent to the south side of the touch screen 110 is moved to a west side of the touch screen 110.

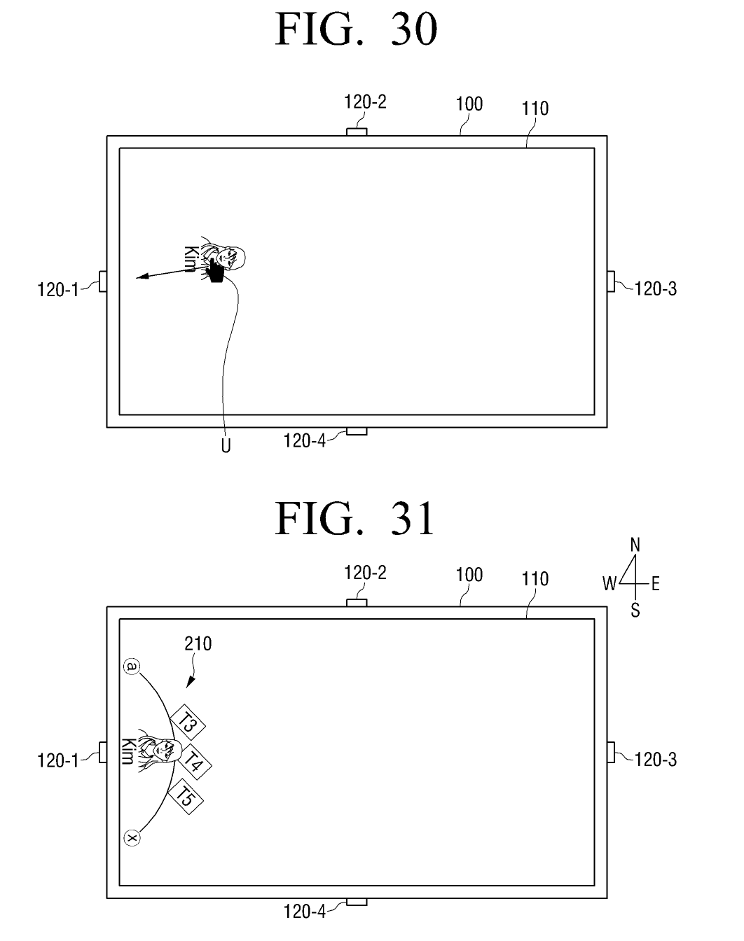

As shown in FIGS. 29 and 30, in a center of the touch screen 100, the whole part of the user tray 210 is not displayed, but only the user information is displayed. As shown in FIG. 30, if the user information that is being dragged is adjacent to the south side of the touch screen 110, a display direction of the user information is changed to an appropriate viewing direction for viewing the user information on the west side of the touch screen 100.

As shown in FIG. 31, if the user information is dropped into an area adjacent to the west side of the touch screen 110, the entire user tray 210 appears. Here, the user tray 210 appears in an appropriate direction to be viewed on the west side of the touch screen 100.

### 7. Closing the User Tray

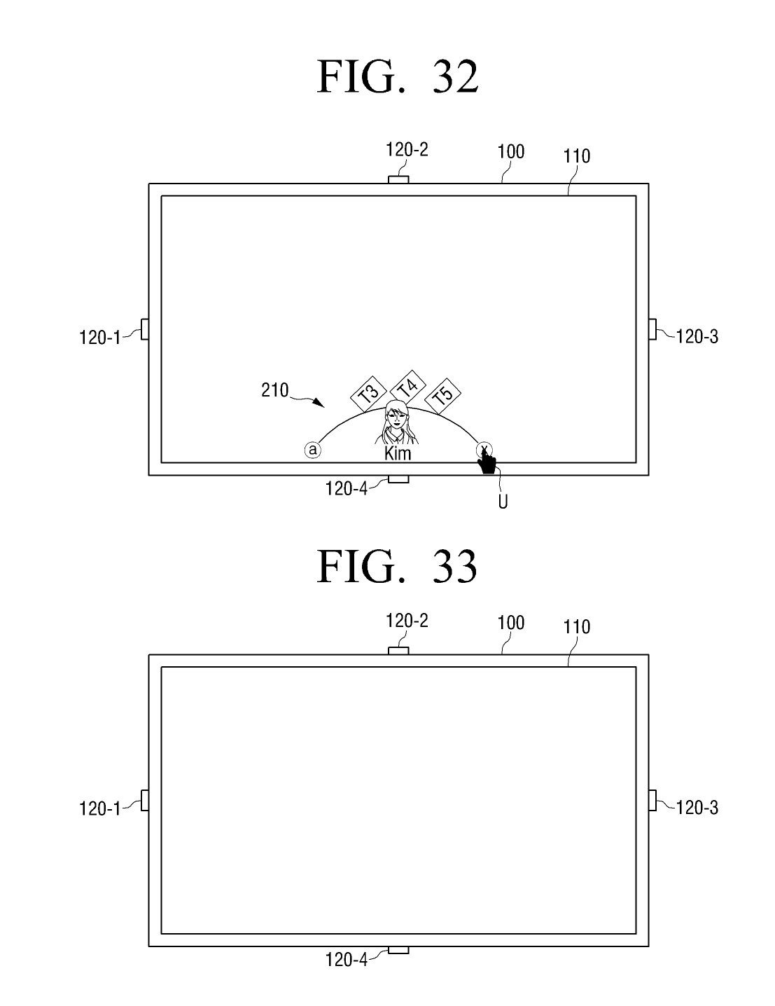

FIGS. 32 and 33 illustrate a method of closing the user tray 210 to make the user tray 210 disappear from the touch screen 110. As shown in FIG. 32, the user U touches the user tray ending icon \textcircled{x} appearing in the user tray 210 to input a user tray ending command.

As shown in FIG. 32, the user tray 210 is ended and thus disappears from the touch screen 110 through the user input, as shown in FIG. 32.

If the user tray 210 is not utilized for a predetermined time, the user tray 210 is automatically ended. Here, a time remaining until the user tray 210 is automatically ended is displayed around the user tray 210 in order to inform the user U of automatic ending of the user tray 210.

This is effective when several user trays appear in the tabletop device 100, for the automatic closing of unused user trays to simplify the touch screen 110 of the tabletop device 100.

### 8. Realization of User Tray for Many Users

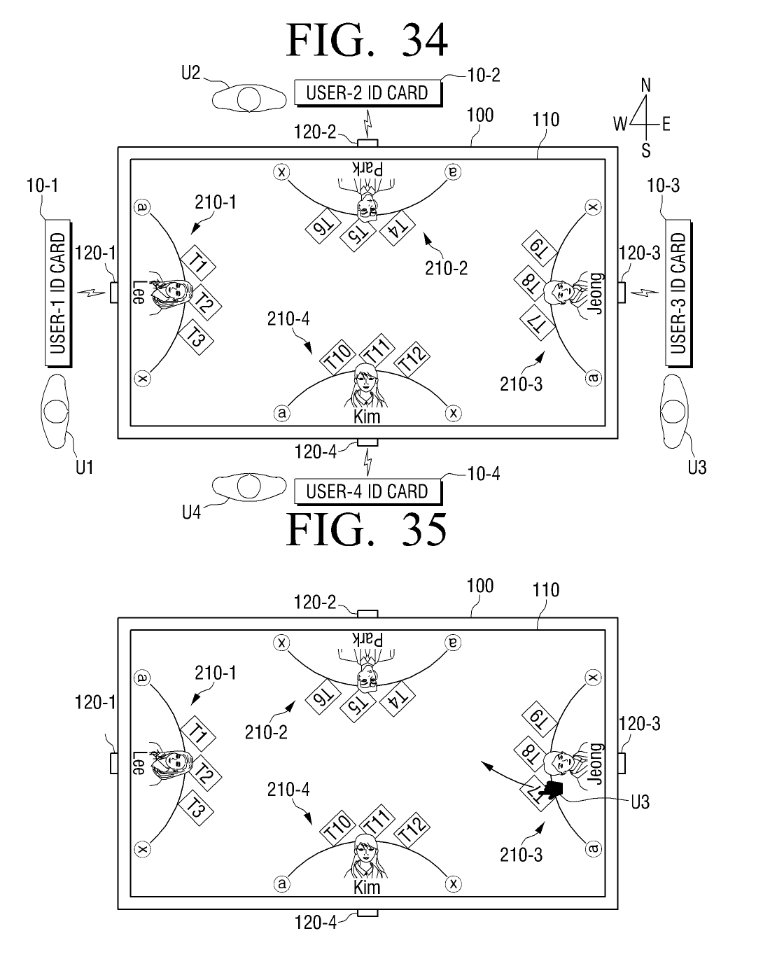

Referring to FIG. 34, first through fourth user trays 210-1 through 210-4 are respectively provided for first through fourth users U1 through U4 so that the first through fourth users U1 through U4 hold a conference by using the tabletop device 100.

Again, referring to FIG. 34, the first user tray 210-1 is for the first user U1 who brings an ID card 10-1 into contact with a first card reader 210-1. Also, the first user tray 210 appears in an area adjacent to a west side of the touch screen 110, i.e. a side of the touch screen 110 nearest to the first user U1 in a direction appropriate for the user U1 to view.

The second user tray 210-2 is for the second user U2 who brings an ID card 10-2 into contact with a second card reader 120-2. Also, the second user tray 210-2 appears in an area adjacent to a north side of the touch screen 110, i.e. a side of the touch screen 110 nearest to the second user U2 in a direction appropriate for the second user U2 to view.

The third user tray 210-3 is for the third user U3 who brings an ID card 10-3 into contact with a third card reader 120-3. Also, the third user tray 210-3 appears in an area adjacent to an east side of the touch screen 10, i.e. a side of the touch screen 110 nearest to the third user U3 in a direction appropriate for the third user U3 to view.

The fourth user tray 210-4 is for the fourth user U4 who brings an ID card 10-4 into contact with a fourth card reader 120-4. Also, the fourth user tray 210-4 appears in an area adjacent to a south side of the touch screen 110, i.e. a side of the touch screen 110 nearest to the fourth user U4 in a direction appropriate for the fourth user U4 to view.

Also, as shown in FIG. 34, tasks included in first through fourth task trays of the first through fourth user trays 210-1 through 210-4 appear in different respective orientations, to display respective user trays in directions appropriate for viewing by respective users, with the tasks of the first through fourth task trays varying according to the firth through fourth users U1 through U4.

The first through fourth user trays 210-1 through 210-4 appearing in the respective areas adjacent to each of the four sides of the touch screens 110 are displayed in directions appropriate for the first through fourth users U1 through U4 to view.

If a task is dragged and dropped from a user tray [symbol] onto the wallpaper, a task execution window appearing on the wallpaper is also displayed in a direction appropriate for a user of the task tray [symbol] to view.

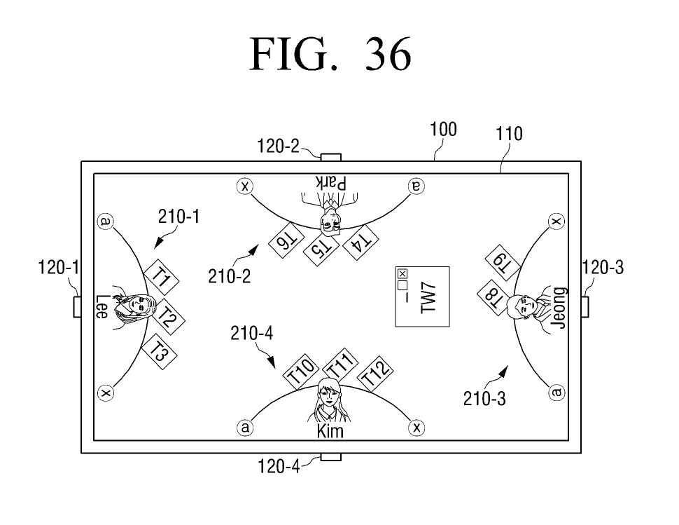

In other words, as shown in FIGS. 35 and 36, if a seventh task T7 is dragged and dropped from a task tray [symbol] of the third user tray 210-3 onto the wallpaper, a seventh task execution window TW7 appearing on the wallpaper is displayed in a direction appropriate for the third user U3 of the third user tray 210-3 to view.

### 9. Guest Tray

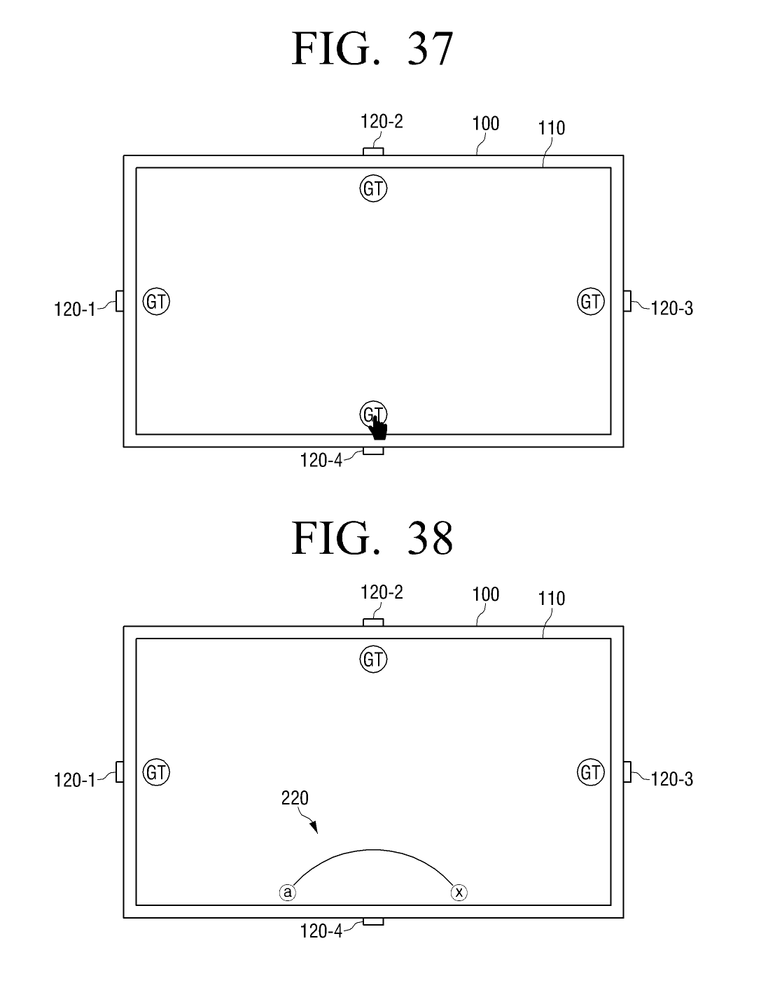

FIGS. 37 through 40 illustrate a guest tray which is a type of user tray. The guest tray refers to a tray for a guest. Here, the guest refers to a person who does not have an ID card.

As shown in FIG. 37, in order to input guest tray calling, a guest G touches one of guest tray calling icons GT appearing in respective centers of four sides of the touch screen 110.

Referring to FIG. 38, through the user input as shown in FIG. 37, the guest tray calling icon GT disappears, and a guest tray 220 appears. As shown in FIG. 38, the guest tray 220 appears around the guest tray calling icon GT that disappeared.

As shown in FIG. 38, the guest tray 220 does not include user information, and a task tray [symbol] of the guest tray 220 includes tasks. Therefore, the guest tray 220 is different from a user tray called by an ID card.

Also, applications included in an application tray of the user tray called by the ID card vary according to users. However, no matter what guest tray is called by a guest, the applications included in the application tray are the same.

Except for the above-described different point, a guest tray control is the same as a user tray control, and thus detailed descriptions of the guest tray control are not repeated here for conciseness.

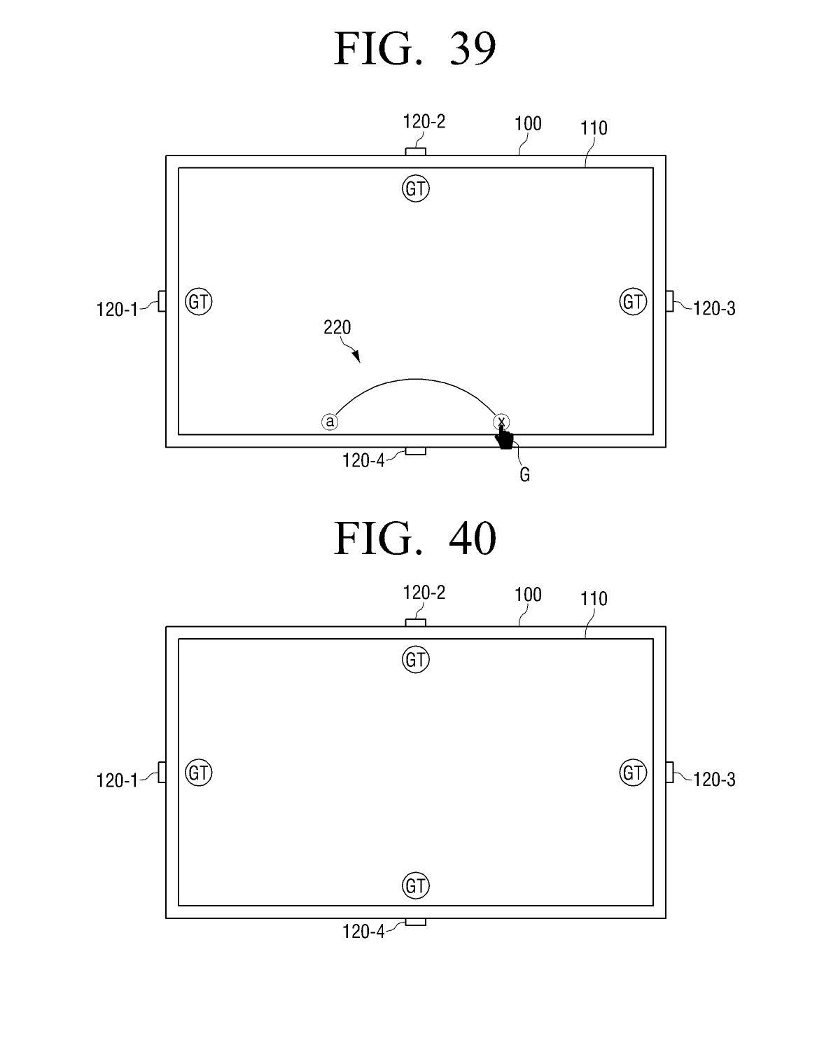

If the guest tray ending icon \textcircled{x} is touched by the guest G, as shown in FIG. 39, the guest tray 220 disappears, and the guest tray calling icon GT reappears, as shown in FIG. 40.

### 10. Other Modifications

In the above-described embodiments, information necessary for providing a user tray is obtained from a user ID card. The information necessary for providing the user tray includes information about tasks which are to be included in a task tray, information about applications which are to be included in an application tray, and user information.

However, the information necessary for providing the user tray, the information about the tasks, the information about the applications, and the user information may be otherwise obtained. For example, the information necessary for providing the user tray, the information about the tasks, the information about the applications, and the user information may be obtained from a Personal Computer (PC) of a user which is connected to the tabletop device 100 through a network, a management server, or a storage medium installed in the tabletop device 100.

In addition, the information necessary for providing the user tray, the information about the tasks, the information about the applications, and the user information may be respectively obtained from different methods. For example, the user information may be obtained from a user ID card, and the information about the tasks and the information about the applications may be obtained from a PC of a user connected to a network, a management server, or a storage medium of the tabletop device 100 by using the user information.

### 11. Device to Which the Present Invention may be Applied

In the above-described embodiments, a user tray is provided in the tabletop device 100. However, the present invention may be applied to other devices besides the tabletop device 100. In other words, the present invention may be applied to any device which may be shared by several users.

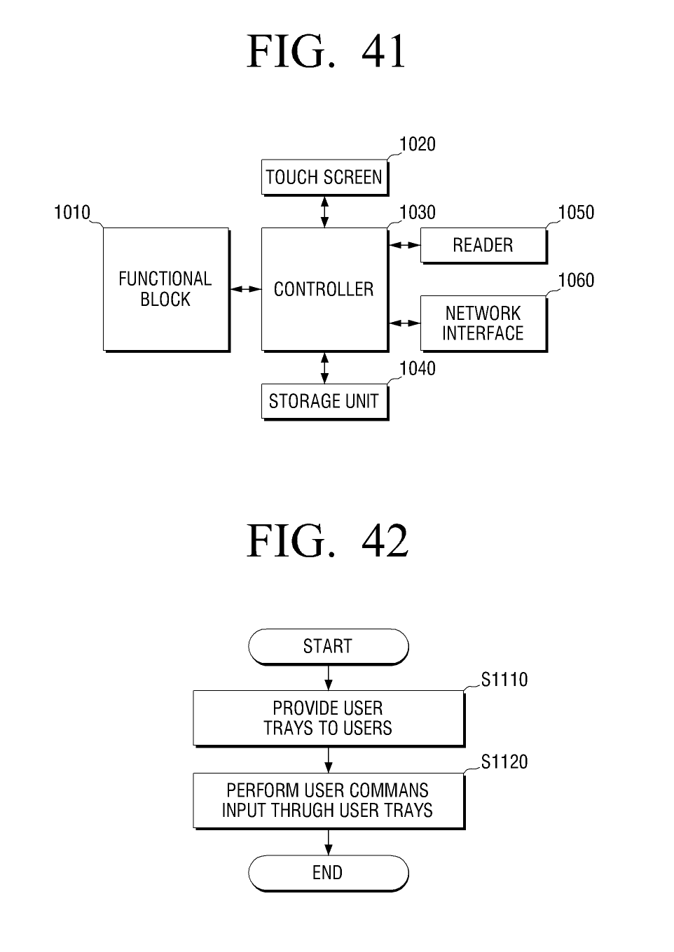

FIG. 41 is block diagram of a device to which the present invention may be applied. Referring to FIG. 41, the device includes a functional block 1010, a touch screen 1020, a controller 1030, a storage unit 1040, a reader 1050, and a network interface 1060.

The functional block 1010 performs a function of the device. If the device is a tabletop device, the functional block 1010 performs a function necessary for a digital conference.

The touch screen 1020 operates as a display which displays a GUI such as an execution result of the functional block 1010, a user tray, a guest tray, and a task execution window. The touch screen 1020 also operates as a user interface to receive a user command, for example by touch and D&D.

The storage unit 1040 is a storage medium which stores an application and files read by the application.

The reader 1050 reads information which is recorded in a user ID card, and the network interface 1060 communicates with another device which is connected through a network.

The controller 1030 provides a user tray as described in the above embodiments to a GUI and performs an input user command by using a task tray and an application tray included in the user tray.

Here, user commands using the task tray include a task execution, a task addition, a task deletion, task scrolling, a task order replacement, and task highlighting. Also, user commands using the application tray include an application execution, application scrolling, an application order replacement, and application highlighting.

Also, the controller 1030 calls/ends an application tray, moves a user tray, and calls/ends the user tray according to the input user command.

FIG. 42 is a flowchart illustrating a control process performed by the controller 1030. As shown in FIG. 42, in step S1110, the controller 1030 provides user trays to users who request the user trays.

The user trays provided in step S1110 include task trays and application trays. Tasks included in the task trays and applications included in the application tray vary according to users.

The tasks included in the task trays are the same on a first stage but may vary through controls of the users.

In step S1120, the controller 1030 performs user commands which are input through the user trays provided in step S1110. The contents performed in step S1120 include a task execution, a task addition, a task deletion, task scrolling, a task order replacement, task highlighting, an application execution, application scrolling, an application order replacement, application highlighting, application tray calling/ending, a user tray movement, and user tray ending/automatic ending.

While the present invention has been particularly shown and described with reference to certain embodiments thereof, it will be understood by those of ordinary skill in the art that various changes in form and details may be made therein without departing from the spirit and scope of the present invention as defined by the following claims.

1. A method for providing a user list, the method comprising:
displaying a first task list, which includes at least one task selected by a first user, in a first area of a display; and
displaying a second task list, which includes at least one task selected by a second user, in a second area of the display.

2. The method as claimed in claim 1, further comprising, if one task included in the first task list is moved to a third area of the display by the first user, displaying a task execution window in which the moved task has been executed.

3. The method as claimed in claim 2, further comprising making the moved task disappear from the first task list.

4. The method as claimed in claim 2, wherein the task execution window is displayed in a direction appropriate for the first user to view.

5. The method as claimed in claim 2, wherein the third area is shared by the first user and the second user.

6. The method as claimed in claim 1, further comprising, if the task execution window displayed in the third area of the display is moved to the first task list, adding a task, which is executed in the moved task execution window, in the first task list.

7. The method as claimed in claim 6, further comprising making the moved task execution window disappear from the third area of the display.

8. The method as claimed in claim 1, further comprising, if one task included in the first task list is moved toward a first direction, deleting the moved task from the first task list.

9. The method as claimed in claim 8, wherein the first direction is a direction facing a side of the display.

10. The method as claimed in claim 1, further comprising displaying information for specifying the first user around the first task list.

11. The method as claimed in claim 1, wherein the first area of the display in which the first task list is displayed is adjacent to one of four sides of the display nearest to the first user.

12. The method as claimed in claim 1, wherein the first task list is displayed in a direction appropriate for the first user to view.

13. The method as claimed in claim 1, wherein at least one task, which is first included in the first task list, is determined by information obtained from a storage medium possessed by the first user.

14. The method as claimed in claim 1, further comprising displaying a first application list, in which at least one application selected by the first user is includable, on the display.

15. The method as claimed in claim 14, wherein displaying the first application list is performed if an icon positioned around the first task list is selected by the first user.

16. The method as claimed in claim 14, wherein the at least one application, which is first included in the first application list, is determined by information obtained from a storage medium possessed by the first user.

17. The method as claimed in claim 14, wherein a direction in which applications are listed in the first application list is different from a direction in which tasks are listed in the first task list.

18. The method as claimed in claim 14, further comprising, if one of applications included in the first application list is moved to a third area of the display by the first user, displaying an application execution window in which the moved application has been executed.

19. The method as claimed in claim 1, further comprising moving and displaying the first task list to a position command by the first user.

20. The method as claimed in claim 19, wherein when moving and displaying the first task list, the first task list is rotated and displayed in a direction appropriate to view on a side of the display adjacent to the position.

21. The method as claimed in claim 1, further comprising:
if a particular icon displayed on the display is selected, displaying a third task list, in which tasks are includable, on the display; and
if a command to end the third task list is input, making the third task list disappear and displaying the particular icon.

22. A device comprising:
a display; and
a controller which displays a first task list, in which at least one task selected by a first user is includable, in a first area of the display and displays a second task list, in which at least one task selected by a second user is includable, in a second area of the display.

23. A method for providing a user list, the method comprising:
displaying a first application list, in which at least one application selected by a first user is includable, in a first area of a display; and
displaying a second application list, in which at least one application selected by a second user is includable, in a second area of the display.
